(19) United States
(12) Patent Application Publication
(10) Pub. No.: US 2015/0365764 A1
(43) Pub. Date: Dec. 17, 2015

(54) METHOD AND ELECTRONIC DEVICE

(71) Applicant: Kabushiki Kaisha Toshiba, Tokyo (JP)

(72) Inventor: Toshifumi YAMAMOTO, Hino Tokyo (JP)

(21) Appl. No.: 14/528,982

(22) Filed: Oct. 30, 2014

Related U.S. Application Data
(60) Provisional application No. 62/011,505, filed on Jun. 12, 2014.

(51) Int. Cl. H04R 3/12; H04R 3/04

(52) U.S. Cl. CPC H04R 3/12; H04R 3/04; H04R 2499/13

(57) ABSTRACT

According to one embodiment, a method includes giving a phase difference between a first phase of a first sound output from a first diaphragm and a second phase of a second sound output from a second diaphragm. The first diaphragm and the second diaphragm are arranged adjacent to each other in a first direction toward a head portion of a listener. The first diaphragm and the second diaphragm extend in a second direction substantially intersecting with the first direction.

### CROSS-REFERENCE TO RELATED APPLICATIONS

This application claims the benefit of U.S. Provisional Patent Application No. 62/011,505, filed Jun. 12, 2014.

### FIELD

Embodiments described herein relate generally to a method and an electronic device.

### BACKGROUND

Conventionally, there has been known a configuration of an in-vehicle audio system or the like, in which a plurality of speakers are arranged adjacent to each other in a room. In such a configuration, sounds output from the speakers resonate and interfere with each other in the room and hence, there exists the case that acoustic effects at a position of a listener are impaired.

In the conventional technique described above, it is desirable to improve the acoustic effects at the position of the listener.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram illustrating a vehicle provided with a speaker device according to an embodiment;

FIG. 2 is an exemplary schematic diagram illustrating a positional relation between the speaker device and a listener (an occupant) in the embodiment;

FIG. 3 is an exemplary schematic diagram for explaining the shape of a diaphragm in the embodiment;

FIG. 4 is an exemplary diagram illustrating each of sound pressures of sounds output in a long side direction and in a short side direction from the speaker device in the embodiment;

FIG. 5 is an exemplary block diagram illustrating an internal configuration of the speaker device in the embodiment;

FIGS. 6A to 6C are exemplary diagrams illustrating sound pressures of sounds output from the speaker device at three different positions, in the embodiment;

FIGS. 7A and 7B are exemplary diagrams illustrating respective filter coefficients used for two FIR filters in the embodiment;

FIG. 8 is an exemplary diagram for explaining the effects of the filter coefficients illustrated in FIGS. 7A and 7B, in the embodiment;

FIG. 9 is an exemplary diagram illustrating each of sound pressures of sounds output from the speaker device in the first direction and in the second direction when only the phase control of the sounds using the filter coefficients illustrated in FIGS. 7A and 7B is performed, in the embodiment;

FIG. 10 is an exemplary diagram for explaining advantageous effects in the embodiment;

FIGS. 11A and 11B are exemplary diagrams illustrating respective filter coefficients used for two FIR filters according to a first modification;

FIG. 12 is an exemplary block diagram illustrating an internal configuration of a speaker device according to a second modification;

FIGS. 13A and 13B are exemplary diagrams illustrating respective filter coefficients used for two FIR filters in the second modification;

FIG. 14 is an exemplary block diagram illustrating an internal configuration of a speaker device according to a third modification.

### DETAILED DESCRIPTION

In general, according to one embodiment, a method comprises giving a phase difference between a first phase of a first sound output from a first diaphragm and a second phase of a second sound output from a second diaphragm. The first diaphragm and the second diaphragm are arranged adjacent to each other in a first direction toward a head portion of a listener. The first diaphragm and the second diaphragm extend in a second direction substantially intersecting with the first direction.

### Embodiment

Hereinafter, an embodiment is specifically explained based on drawings. The explanation is made below with respect to an example that applies a technique in the embodiment to a speaker device provided to a vehicle. However, the technique in the embodiment is also applicable to a general speaker device other than the speaker device provided to the vehicle. The technique in the embodiment is also applicable to a general electronic device other than the speaker device, provided that the electronic device is equipped with a diaphragm that is capable of outputting sounds.

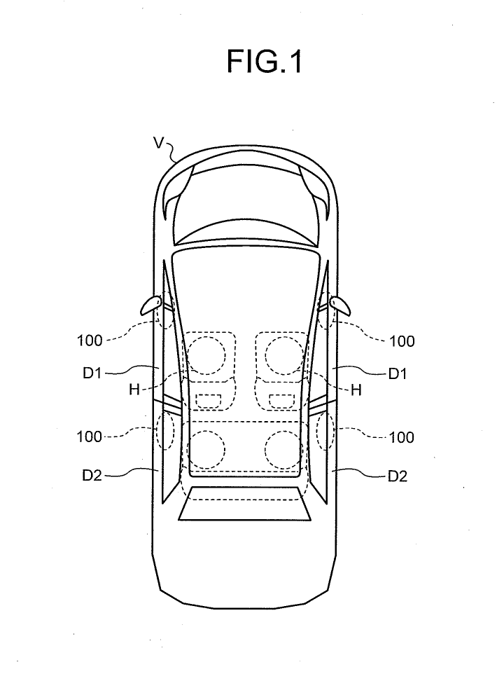

First of all, with reference to FIG. 1 to FIG. 10, the schematic configuration of a speaker device 100 according to the embodiment is explained. Here, the speaker device 100 is one example of an “electronic device”.

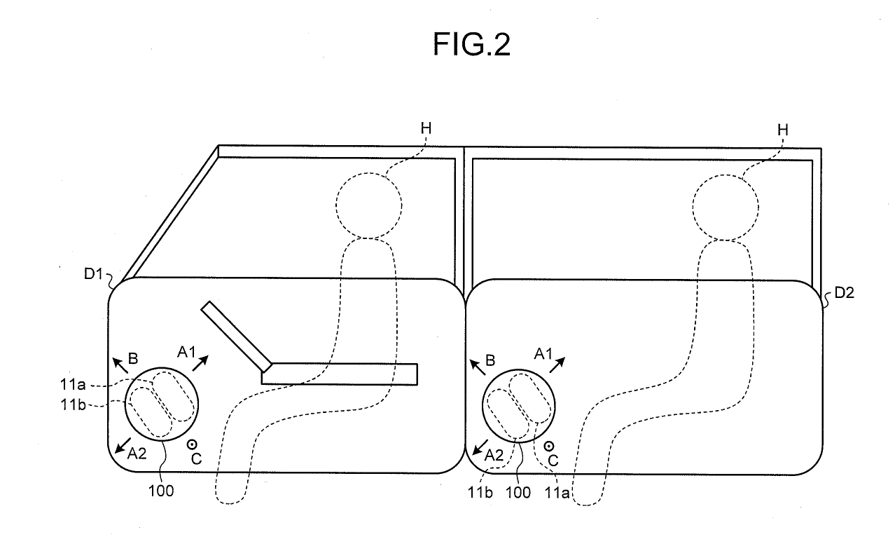

As illustrated in FIG. 1 and FIG. 2, the speaker device 100 is provided to each of a front door D1 and a rear door D2 of a vehicle V.

As illustrated in FIG. 2, each speaker device 100 is arranged on the foot side of an occupant H in the vehicle V, the occupant H being a listener who listens sounds from the speaker device 100. Furthermore, the speaker device 100 is provided with two speakers 11a and 11b. The speaker 11a is arranged at a position closer to the occupant H than the speaker 11b, and the speaker 11b is arranged at a position more distant from the occupant H than the speaker 11a.

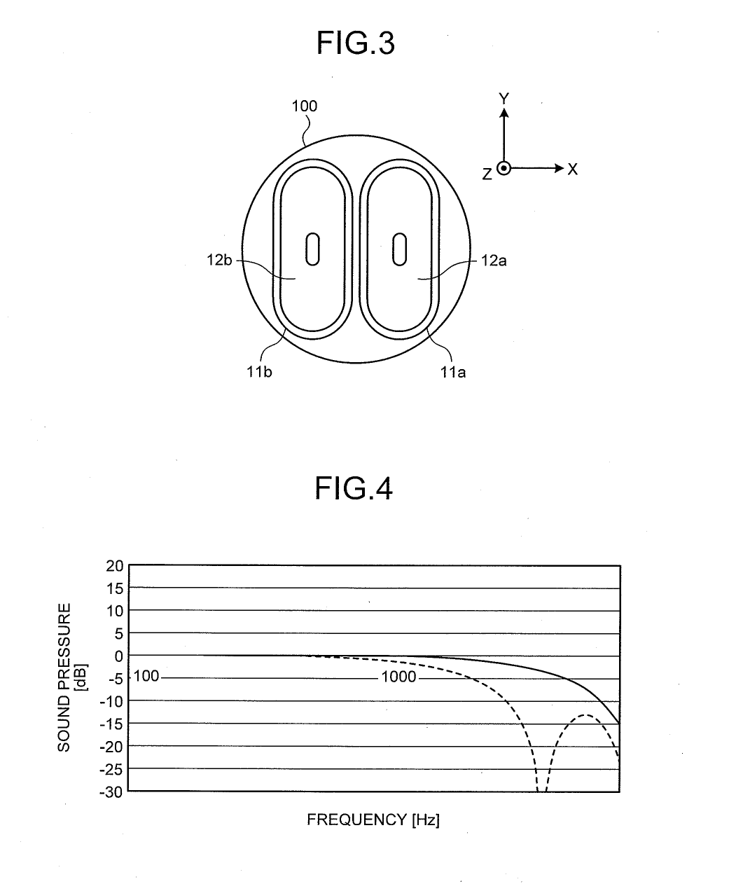

Furthermore, as illustrated in FIG. 3, the speakers 11a and 11b are provided with diaphragms 12a and 12b, respectively. The diaphragms 12a and 12b are arranged adjacent to each other in the X direction. Each of the diaphragms 12a and 12b has an oval shape that extends in the Y direction orthogonal to the X direction. Here, the shape of each of the diaphragm 12a and 12b in the embodiment may be any elongated shape that extends in one direction or, for example, any rectangular shape that extends in the Y direction. The diaphragms 12a and 12b are one example of a “first diaphragm” and one example of a “second diaphragm,” respectively.

Here, in such an elongated-shaped diaphragm as the diaphragms 12a and 12b in the embodiment, the relation between the sound pressures of sounds output in the short side direction (see an arrow X in FIG. 3) and the sound pressures of sounds output in the long side direction (see an arrow Y in FIG. 3) is illustrated in FIG. 4.

FIG. 4 is a graph illustrating results obtained by calculating, assuming that a diaphragm is approximately 50 mm in length in the short side direction and approximately 110 mm in length in the long side direction, a sound pressure characteristic in each frequency band of a sound output in the direction inclined to make an angle 60 deg. with respect to the normal direction (see an arrow Z in FIG. 3) of the diaphragm toward the short side direction, and a sound pressure characteristic in each frequency band of a second sound output in the direction inclined to make an angle 60 deg. with respect to the normal direction toward the long side direction. In FIG. 4, the sound pressure characteristics of the sounds output in the short side direction are expressed by a solid-line graph, and the sound pressure characteristics of the sounds output in the long side direction are expressed by a dotted-line graph.

As can be understood from FIG. 4, a decrease in the sound pressure in a high frequency band of the sound output in the short side direction is less than that of the sound output in the long side direction. That is, the sound pressure of the sound output in the long side direction decreases significantly in the high frequency band. On the other hand, even in the high frequency band, the sound output in the short side direction does not decrease so significantly as the sound output in the long side direction. Therefore, when the diaphragm is arranged so that the short side direction of the diaphragm and the direction toward the head portion of a listener (the occupant H in FIG. 2) coincide with each other, an advantageous effect equivalent to giving directivity to a sound can be acquired so that the sound from a diaphragm mainly advances to a listener's head side.

In the embodiment, as illustrated in FIGS. 2 and 3, the speaker device 100 is arranged so that the short side direction (see an arrow X in FIG. 3) of the diaphragms 12a and 12b coincides with a first direction (see an arrow A1 in FIG. 2) toward the head portion of the occupant H, and the long side direction (see an arrow Y in FIG. 3) of the diaphragms 12a and 12b coincides with a second direction (see an arrow B in FIG. 2) that is orthogonal to the first direction. Accordingly, an advantageous effect equivalent to giving directivity to a sound can be acquired so that the sound from the speaker device 100 mainly advances in the first direction rather than in the second direction. Furthermore, to consider a case where the speaker device 100 is configured as described above, when the speaker device 100 arranged in a front door D1 and the speaker device 100 arranged in a rear door D2 output, for example, sounds different from each other, the sound pressure of the sound output in the second direction from the speaker device 100 arranged in the rear door D2 can be relatively reduced compared with the sound pressure of the sound output in the first direction from the speaker device 100 arranged in the front door D1. This can prevent the sound from the speaker device 100 arranged in the front door D1 and the sound from the speaker device 100 arranged in the rear door D2 from being mixed with each other and reaching the occupant H in a front seat.

Next, the internal configuration of the speaker device 100 is more specifically explained.

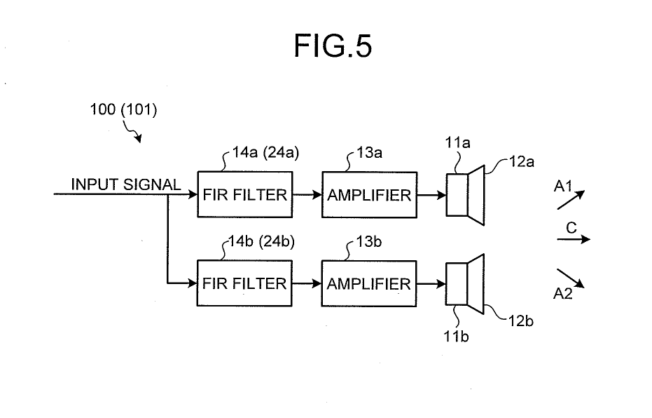

As illustrated in FIG. 5, the speaker device 100 is provided with speakers 11a and 11b that respectively have diaphragms 12a and 12b, amplifiers 13a and 13b, and FIR filters 14a and 14b.

The amplifiers 13a and 13b are connected to the speakers 11a and 11b, respectively. The FIR filters 14a and 14b are connected to the amplifiers 13a and 13b, respectively.

Here, in the configuration as in the embodiment (see FIG. 2) that the speaker device 100 is arranged on the foot side of the occupant H, when no processing is performed with respect to an input signal, sounds output from the speakers 11a and 11b do not advance toward the head of the occupant H (see arrow A1) but advance toward the front side of the speaker device 100 (see arrow C) and the foot side of the occupant H (see arrow A2). Accordingly, the reflection of sounds from interior surfaces and the like on the foot side of the occupant H in a vehicle and interference of sounds are liable to easily occur thus giving rise to a high possibility that deterioration of sound quality occurs. Therefore, in the configuration of the embodiment, it is desired that sounds are advanced toward the head of the occupant H by processing that gives directivity, for example, to the sounds so as to obtain the optimal acoustic effects at a position on the head of the occupant H.

Accordingly, in the embodiment, in order to obtain the optimal acoustic effects at a position on the head of the occupant H, a phase of a first sound output from the speaker 11a (diaphragm 12a) and a phase of a second sound output from the speaker 11b (diaphragm 12b) are shifted from each other. To be more specific, the phase of the first sound is delayed by π/4 with respect to an input signal using the FIR filter 14a, and the phase of the second sound is advanced by π/4 with respect to the input signal using the FIR filter 14b. Accordingly, as explained below, it is possible to improve the acoustic effects at a position on the head of the occupant H. Hereinafter, in order to explain the principle of above, a state of each sound at a frequency at which a phase difference is affected effectively is explained.

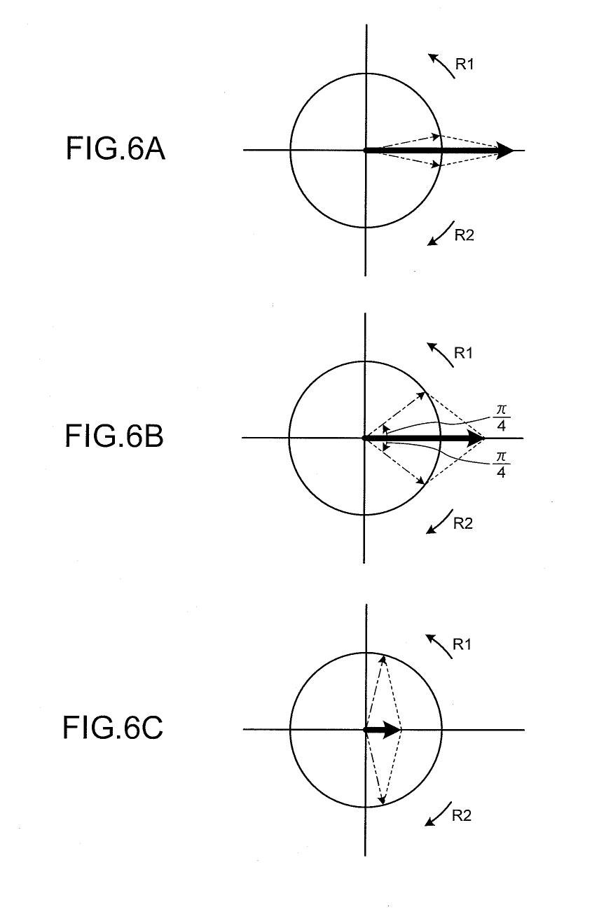

FIGS. 6A to 6C are exemplary diagrams illustrating the sound pressure of a composite tone of the first sound and the second sound in the case where the phases of the first sound and the second sound are shifted as above. In FIGS. 6A to 6C, the first sound is indicated by an arrow described by a dashed-dotted line, the second sound is indicated by an arrow described by a chain double-dashed line, and the composite tone is indicated by an arrow described by a thick line. Furthermore, in FIGS. 6A to 6C, the direction of the phase advanced is indicated by an arrow R1 in the counterclockwise direction, and the direction of the phase delayed is indicated by an arrow R2 in the clockwise direction.

FIG. 6A is an exemplary diagram illustrating the sound pressure of a composite tone at a position on the head of the occupant H (see the arrow A1 in FIG. 2). FIG. 6B is an exemplary diagram illustrating the sound pressure of a composite sound at a position on the front side of the speaker device 100 (see the arrow C in FIG. 2). FIG. 6C is an exemplary diagram illustrating the sound pressure of a composite tone at a position on the foot side of the occupant H (see the arrow A2 in FIG. 2).

As illustrated in FIG. 6B, at the position on the front side of the speaker device 100 (see the arrow C in FIG. 2), as the above-mentioned setting, the phase of the first sound is delayed by π/4 with respect to an input signal, and the phase of the second sound is advanced by π/4 with respect to the input signal.

On the other hand, at a position on the head of the occupant H (see the arrow A1 in FIG. 2), a distance relative to the speaker 11a is shorter compared with the case in FIG. 6B and hence, the delay in phase of the first sound is set off in proportion to the decrease of the distance. Therefore, at a position on the head of the occupant H, as illustrated in FIG. 6A, the delay in phase of the first sound becomes smaller than π/4. Furthermore, at a position on the head of the occupant H, a distance relative to the speaker 11b is longer compared with the above-mentioned case in FIG. 6B and hence, the advance in phase of the second sound is set off in proportion to the increase of the distance. Therefore, at a position on the head of the occupant H, as illustrated in FIG. 6A, the advance in phase of the second sound becomes smaller than π/4.

As a result, according to the embodiment, the first sound and the second sound intensify with each other at a position on the head of the occupant H (see the arrow A1 in FIG. 2) thus increasing the sound pressure of the composite tone at a position on the head of the occupant H compared with the above-mentioned case in FIG. 6B. Therefore, according to the embodiment, even when a sound volume of an entire system is lowered, it is possible to maintain the level of the volume at a position on the head of the occupant H thus improving sound output efficiency.

Furthermore, at a position on the foot side of the occupant H (see the arrow A2 in FIG. 2), a distance relative to the speaker 11a is longer compared with the above-mentioned case in FIG. 6B and hence, the delay in phase of the first sound is increased in proportion to the increase of the distance. Therefore, at a position on the foot side of the occupant H, as illustrated in FIG. 6C, the delay in phase of the first sound becomes larger than π/4. In addition, at a position on the foot side of the occupant H, a distance relative to the speaker 11b is shorter compared with the case in FIG. 6B and hence, the advance in phase of the second sound is increased in proportion to the decrease of the distance. Therefore, at a position on the foot side of the occupant H, as illustrated in FIG. 6C, the advance in phase of the second sound becomes larger than π/4.

As a result, according to the embodiment, the first sound and the second sound are canceled each other at a position on the foot side of the occupant H (see the arrow A2 in FIG. 2) thus decreasing the sound pressure of the composite tone at a position on the foot side of the occupant H compared with the above-mentioned case in FIG. 6B. Therefore, according to the embodiment, it is possible to suppress the deterioration of the sound quality of sounds audible at a position on the head of the occupant H attributed to the reflection of the sounds output toward the foot side of the occupant H from interior surfaces, the occupant H, or the like in a vehicle and interference of the sounds, thereby an acoustic effects at a position on the head of the occupant H can be improved.

Here, both the delay in phase of the first sound and the advance in phase of the second sound at the position in FIG. 6B are set to π/4 based on the following reason. That is, when the phase difference between the first sound and the second sound is excessively increased, components of these sounds that are canceled each other are increased at the time when these sounds are output from the speakers 11a and 11b, thereby the output efficiency is lowered. Accordingly, in the embodiment, it is desirable that both the delay in phase of the first sound and the advance in phase of the second sound be set to 0 at the position in FIG. 6A at which the most intensified sound pressure is required, and both the delay in phase of the first sound and the advance in phase of the second sound be set to π/2 at the position in FIG. 6C at which the most lowered sound pressure is required. Consequently, in the embodiment, both the delay in phase of the first sound and the advance in phase of the second sound are set to π/4 that is a value intermediate between 0 and π/2 at the position in FIG. 6B that is a position intermediate between the position in FIG. 6A and the position in FIG. 6C. This configuration can improve acoustic effects effectively at the position in FIG. 6A.

In addition, in the embodiment, in order to further improve the acoustic effects at the position on the head of the occupant H, the output of the first sound is delayed with respect to the output of the second sound by a time corresponding to a path difference between the first sound and the second sound in a high frequency band. Here, in the high frequency band, interference between the first sound and the second sound is liable to easily occur attributed to a large phase change by a distance difference, as described later. The path difference corresponds to a difference in distance from the speakers 11a and 11b to the position on the head of the occupant H. Accordingly, it is possible to make a time when the first sound arrives at the position on the head of the occupant H and a time when the second sound arrives at the position on the head of the occupant H equal to each other, thereby the acoustic effects at the position on the head of the occupant H can be further improved.

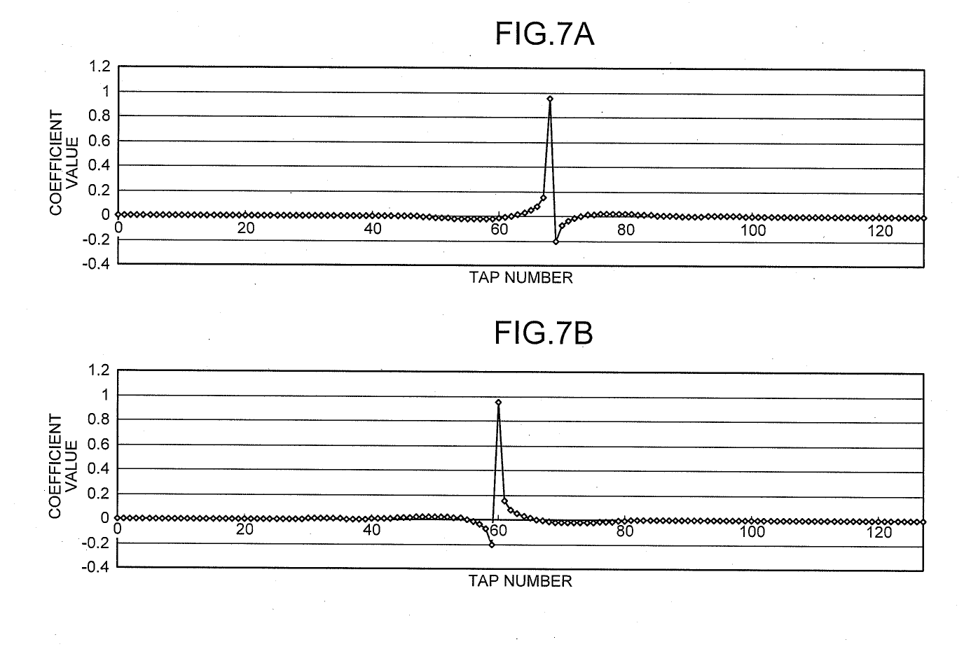

The above-mentioned phase control and time control is achieved by setting filter coefficients as illustrated in FIGS. 7A and 7B to the FIR filters 14a and 14b. FIGS. 7A and 7B are exemplary diagrams illustrating filter coefficients set to the FIR filters 14a and 14b, respectively. In examples illustrated in FIGS. 7A and 7B, the filter coefficient is calculated assuming that a sampling frequency is 48 kHz.

FIG. 7A is an exemplary diagram illustrating a filter coefficient designed such that the phase of the first sound is delayed by t/4 with respect to a signal that is delayed by 64 samples with respect to an input signal and the output of the first sound in a high frequency band is delayed by one-half of a time difference corresponding to the path difference between the first sound and the second sound. The filter coefficient illustrated in FIG. 7A is designed such that the output of the first sound is delayed by one-half of a time difference corresponding to a path difference of approximately 50 mm in a high frequency band of 3 kHz or higher. FIG. 7B is an exemplary diagram illustrating a filter coefficient designed such that the phase of the second sound is advanced by π/4 with respect to a signal that is delayed by 64 samples with respect to an input signal and the output of the second sound in a high frequency band decreases the delay thereof by one-half of a time difference corresponding to the path difference between the first sound and the second sound. The filter coefficient illustrated in FIG. 7B is designed such that the delay in the output of the second sound is decreased by one-half of a time difference corresponding to a path difference of 50 mm at a high frequency band of 3 kHz or higher.

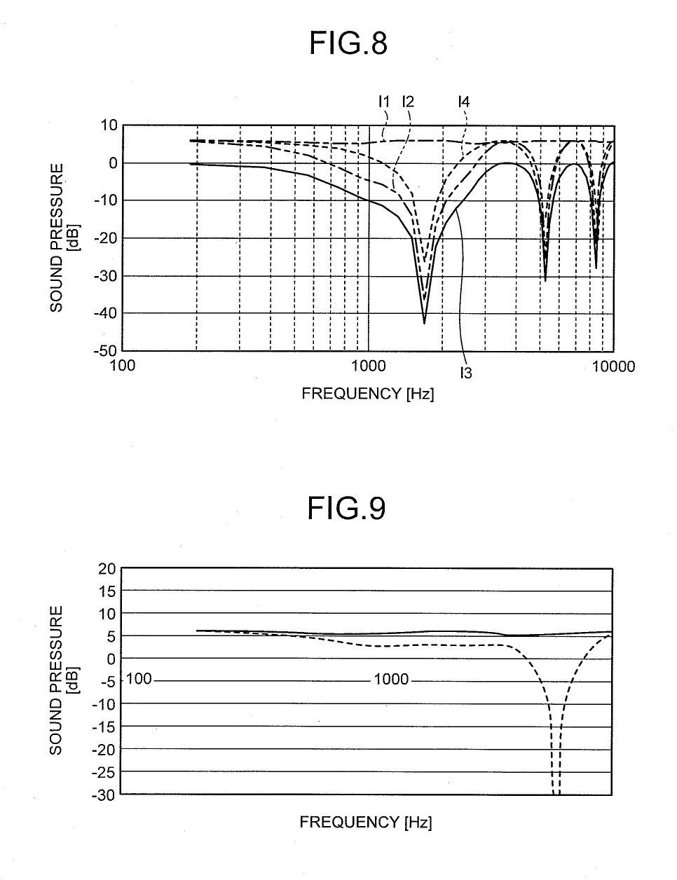

When the above-mentioned filter coefficients illustrated in FIGS. 7A and 7B are used, the sound pressure of a composite tone of the first sound and the second sound is expressed as a graph illustrated in FIG. 8.

A dashed-dotted line 11 in FIG. 8 indicates the sound pressure of the composite tone at a position on the head of the occupant H (see the arrow A1 in FIG. 2). Furthermore, a chain double-dashed line 12 in FIG. 8 indicates the sound pressure of the composite tone at a position on the foot side of the occupant H (see the arrow A2 in FIG. 2). In addition, a solid line 13 in FIG. 8 indicates a sound pressure ratio of a composite tone at a position on the head of the occupant H to a composite tone at a position on the foot side of the occupant H.

A dotted line 14 in FIG. 8 indicates, as a comparative example, the sound pressure of the composite tone at a position on the foot side of the occupant H when a filter coefficient in which only a delay of time corresponding to the path difference between the first sound and the second sound is incorporated without using the filter coefficient (see FIGS. 7A and 7B) in which the phase control is incorporated in the embodiment. The dotted line 14 is positioned on an upper side (on a high sound pressure side) of the above-mentioned chain double-dashed line 12. It is understood that, according to the embodiment (chain double-dashed line 12) in which the phase control is incorporated in the filter coefficient, the sound pressure of the composite tone at a position on the foot side of the occupant H is decreased compared with the comparative example (dotted line 14) in which the phase control is not incorporated in the filter coefficient. That is, according to the embodiment, as the filter coefficient in which the phase control is incorporated is used, the reflections and the interference of sounds at the position on the foot side of the occupant H can be further suppressed, thereby the acoustic effects at the position on the head opposite to the foot side of the occupant H can be further improved.

FIG. 9 is a graph illustrating a result obtained by calculating, in the case where the filter coefficients illustrated in FIGS. 7A and 7B are used, a sound pressure characteristic in each frequency band of the sound output in the first direction (see the arrow A1 in FIG. 2) toward the head of the occupant H, and a sound pressure characteristic in each frequency band of the sound output in the second direction (see the arrow B in FIG. 2) that is orthogonal to the first direction, without considering the shape of the diaphragms 12a and 12b. In FIG. 9, the sound pressure characteristics of the sounds output in the first direction are indicated by a solid-line graph, and the sound pressure characteristics of the sounds output in the second direction are indicated by a dotted-line graph.

As illustrated in FIG. 9, in the case where the filter coefficients illustrated in FIGS. 7A and 7B are used, there exists no region of the graph in which a sound pressure decreases significantly in the entire frequency band with respect to the sound output in the first direction toward the head portion of the occupant H. On the other hand, in the case where the filter coefficients illustrated in FIGS. 7A and 7B are used, there exists a region of the graph in which a sound pressure decreases significantly in a high frequency band with respect to the sound output in the second direction orthogonal to the first direction. Therefore, in the case where the filter coefficients illustrated in FIGS. 7A and 7B are used, an advantageous effect equivalent to giving directivity to a sound can be obtained so that the sound mainly advances in the first direction rather than the second direction at least in the high frequency band.

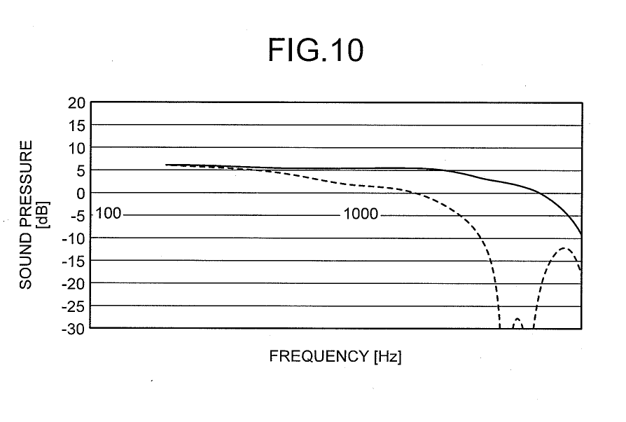

FIG. 10 is a graph illustrating each of the sound pressure characteristics of the sounds output in the first direction and in the second direction in the case where, after controlling the phase of the sound based on the filter coefficients illustrated in FIGS. 7A and 7B, each of the diaphragms 12a and 12b is formed in an elongated shape, and the diaphragms 12a and 12b are arranged so that the short side direction (the X direction in FIG. 3) coincides with the first direction (see the arrow A1 in FIG. 2) and the long side direction (the Y direction in FIG. 3) coincides with the second direction (see the arrow B in FIG. 2). In FIG. 10, the sound pressure characteristics of the sounds output in the first direction (the short side direction) are indicated by a solid-line graph, and the sound pressure characteristics of the sounds output in the second direction (the long side direction) are indicated by a dotted-line graph.

The result illustrated in FIG. 10 shows a result such that the result illustrated in FIG. 4 and the result illustrated in FIG. 9 are combined with each other. That is, as illustrated in FIG. 10, the difference in sound pressure between the sound output in the first direction and the sound output in the second direction can be further increased when the shape and arrangement of each of the diaphragms 12a and 12b are appropriately configured in addition to controlling the phase of the sound, compared with the case that only the phase of the sound is controlled (see FIG. 9). As a result, an advantageous effect equivalent to giving directivity to a sound can be obtained more efficiently so that the sounds from the diaphragms 12a and 12b mainly advance in the first direction rather than in the second direction; that is, in the direction toward the head portion of the occupant H.

As explained heretofore, in the embodiment, the diaphragms 12a and 12b are arranged adjacent to each other in the first direction (see the arrow A1 in FIG. 2) toward the head portion of the occupant H, and each of the diaphragms 12a and 12b is formed so as to extend in the second direction (see the arrow B in FIG. 2) that intersects with the first direction. To be more specific, the diaphragms 12a and 12b are arranged so that the short side direction (see the arrow X in FIG. 3) coincides with the first direction, and the long side direction (see the arrow Y in FIG. 3) coincides with the second direction. Accordingly, the sound pressure of the sound output in the first direction can be made larger than the sound pressure of the sound output in the second direction (see FIG. 4), thereby an advantageous effect can be obtained, the advantageous effect being equivalent to giving directivity to a sound so that the sounds from the diaphragms 12a and 12b mainly advance in the first direction rather than in the second direction.

Furthermore, in the embodiment, each of the FIR filters 14a and 14b is configured to provide the predetermined phase difference between the phase of the sound output from the diaphragm 12a and the phase of the sound output from the diaphragm 12b. To be more specific, the FIR filter 14a is configured so that the phase of the sound output from the diaphragm 12a of the speaker 11a provided at the position close to the occupant H is delayed with respect to the phase of an input signal, and the FIR filter 14b is configured so that the phase of the sound output from the diaphragm 12b of the speaker 11b provided at the position distant from the occupant H is advanced with respect to the phase of the input signal. Accordingly, the sound pressure of the sound output in the first direction can be made larger than the sound pressure of the sound output in the direction opposite to the first direction and hence (see FIG. 8), an advantageous effect equivalent to giving directivity to a sound can be obtained so that the sounds from the diaphragms 12a and 12b mainly advance to the head side of the occupant H rather than the foot side of the occupant H. Further, the sound pressure of the sound output in the first direction can also be increased so as to be higher than the sound pressure of the sound output in the second direction orthogonal to the first direction (see FIG. 9) and hence, an advantageous effect equivalent to giving directivity to a sound can be obtained so that the sounds from diaphragms 12a and 12b mainly advance in the first direction rather than the second direction. Here, the first direction is the direction toward the head side of the occupant H (see the arrow A1 in FIG. 2), and the second direction is the direction toward the foot side of the occupant H (see the arrow A2 in FIG. 2).

According to the embodiment, both the advantageous effect of directivity based on the arrangements and shapes of the diaphragms 12a and 12b (see FIG. 4) and the advantageous effect of directivity based on the control of a phase (see FIGS. 8 and 9) are obtained, thereby the advantageous effect of directivity (see FIG. 10) can be further enhanced. As a result, the acoustic effects at a position on the head side of the occupant H can be further improved.

As described above, in the embodiment, the advantageous effect of directivity is obtained by appropriately configuring the shapes and arrangements of the diaphragms 12a and 12b in addition to controlling the phase of a sound. Consequently, according to the embodiment, it is possible to improve acoustic effects at a position on the head of the occupant H by, for example, an easier method without performing filtering processing accompanied with complicate calculations in consideration of acoustic characteristics or the like of the speakers 11a and 11b. This technique in the embodiment requires no headroom margin for filtering and is effective particularly when the installation space of a sound device is restricted, for example.

Here, the embodiment illustrates an example in which the phases of the first sound and the second sound are shifted by the same amount of phase (π/4) with respect to an input signal. However, another embodiment in which a phase to be shifted with respect to an input signal is made different between the first sound and the second sound is conceivable. For example, the phase of the second sound may be advanced by π/2 without shifting the phase of the first sound. However, the configuration of the embodiment in which the phases of the first sound and the second sound are shifted by the same amount of phase (π/4) with respect to an input signal achieves advantageous effects more easily since it is unnecessary to perform processing that adjusts the phase of the composite tone of the first sound and the second sound to the phase of the input signal.

In addition, the other embodiment in which the phases of the first sound and the second sound are shifted by an amount apart from π/4 is also conceivable. In this case, the amount of shifting each of the phases of the first sound and the second sound may be determined so that the phase difference between the first sound and the second sound in each frequency band becomes π in the most desired direction to suppress a sound pressure.

Furthermore, in the embodiment, the phases of the first sound and the second sound are set close to each other at a position on the head side of an occupant. However, there exists the case that the degree of a phase shift is changed depending on a frequency. In this case, a sound pressure difference attributed to a phase difference may be generated. Accordingly, correction characteristics for correcting the sound pressure difference can be incorporated into the design of filter coefficients. That is, the filter coefficients can be designed by performing an inverse Fourier transform after correcting a decrease in amplitude due to the phase difference in advance.

### First Modification

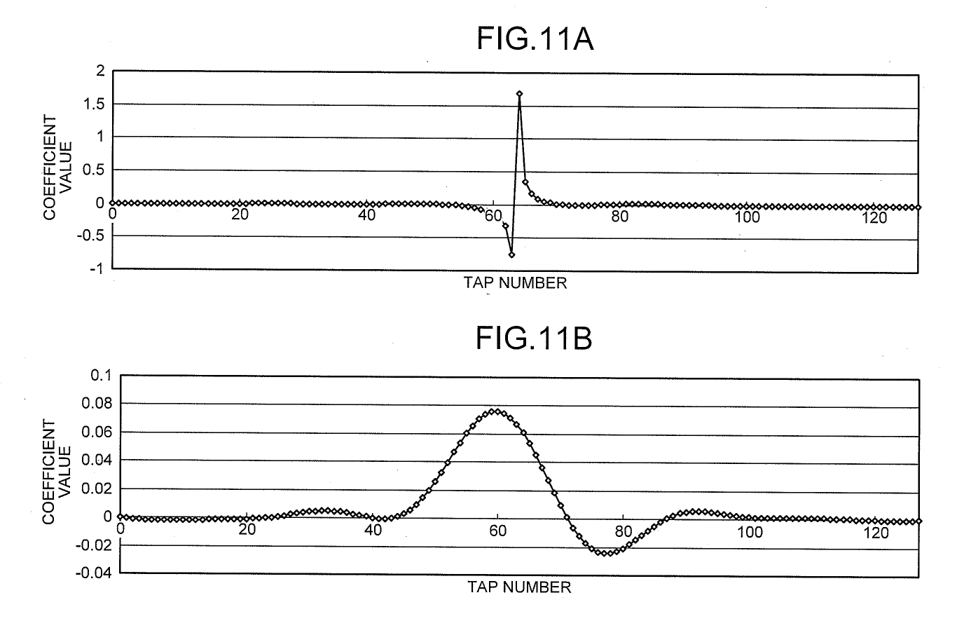

Next, with reference to FIG. 5 and FIGS. 11A and 11B, a first modification is explained. In the first modification, sounds in a high frequency band that are liable to easily interfere with each other are output from only one of the speakers 11a and 11b.

As illustrated in FIG. 5, a speaker device 101 according to the first modification has a substantially same configuration as the speaker device 100 according to the above-mentioned embodiment. The speaker device 101 is one example of an “electronic device”.

In the first modification, one of FIR filters 24a and 24b filters a high frequency component of one of the first sound and the second sound. With this configuration, one of the first sound and the second sound is output in a state that the high frequency component thereof is filtered, and the other one of the first sound and the second sound is output in a state that the high frequency component is included therein.

As described above, when the phases of the first sound and the second sound are controlled, the same effect as the case of giving directivity to sounds from the speakers 11a and 11b so that the sounds advance in the direction toward the head of the occupant H (see arrow A1) can be obtained. However, a variation in phase difference of the first sound and the second sound between the head and the foot side (see arrow A2) of the occupant H depends on the wavelengths of the sounds.

That is, in a low-pitched sound range, a wavelength is long and hence, the path difference between the first sound and the second sound (a distance between the two speakers 11a and 11b) becomes small relative to the wavelength. Therefore, in the low-pitched sound range, the phase difference between the first sound and the second sound becomes small, and a variation in sound pressure between the head and the foot side of the occupant H becomes small. Furthermore, in a high-pitched sound range, a wavelength is short and hence, the path difference between the first sound and the second sound becomes large relative to the wavelength.

Here, as described above, the effect of the phase control is maximized when the phases of the first sound and the second sound are respectively shifted by π/4 to set the phase difference therebetween to π/2. To set the phase difference to π/2 is, in other words, to set the path difference between the first sound and the second sound equal to one-fourth of the wavelength. Accordingly, when the wavelength is shorter than four times of the path difference, the phase is excessively rotated, and it becomes difficult to acquire the effect of the phase control.

In addition, the following case is considered; that is, the phases of the first sound and the second sound are respectively shifted by an amount larger than π/2 to set the phase difference therebetween larger than π. To set the phase difference larger than π is to set the path difference shorter than one-half of the wavelength. In this case, the sound pressure of the composite tone on the foot side of the occupant H is larger than the sound pressure of the composite tone on the head of the occupant H and hence, the reflections and interference of the sounds on the foot side of the occupant H become large, and it is impossible to obtain the effect of directivity as in the above-mentioned embodiment.

For this reason, the first modification sets, in a high frequency band corresponding to a wavelength in the vicinity of ¼ to ½ of a path difference, filter coefficients of the FIR filters 24a and 24b so that a sound is output only from the speaker 11a without outputting a sound from the speaker 11b. That is, in the first modification, the filter coefficient of the FIR filter 24b is designed such that the FIR filter 24b also has a function as a low-pass filter. Accordingly, it is possible to suppress the interference of sounds also in a high frequency band. FIGS. 11A and 11B are exemplary diagrams illustrating filter coefficients designed for obtaining such effects.

FIG. 11A is an exemplary diagram illustrating a filter coefficient to be set in the FIR filter 24a. The filter coefficient illustrated in FIG. 11A is designed such that a gain becomes 2 in a high frequency band (a frequency band of 2625 Hz or higher, as one example). Furthermore, FIG. 11B is an exemplary diagram illustrating a filter coefficient to be set in the FIR filter 24b. The filter coefficient illustrated in FIG. 11B is designed such that a gain becomes 0 in a high frequency band.

### Second Modification

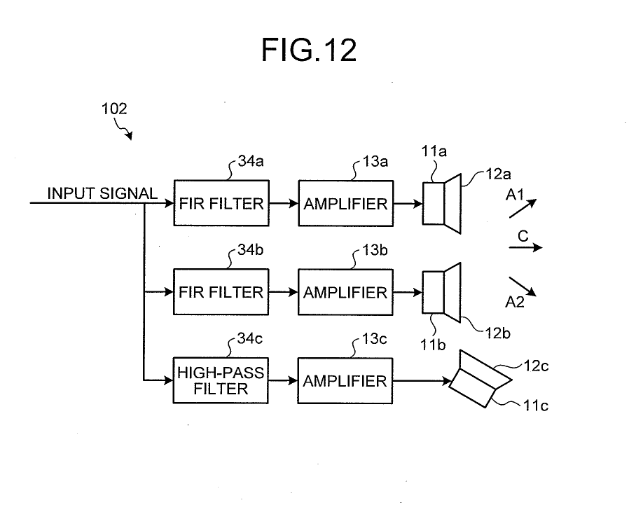

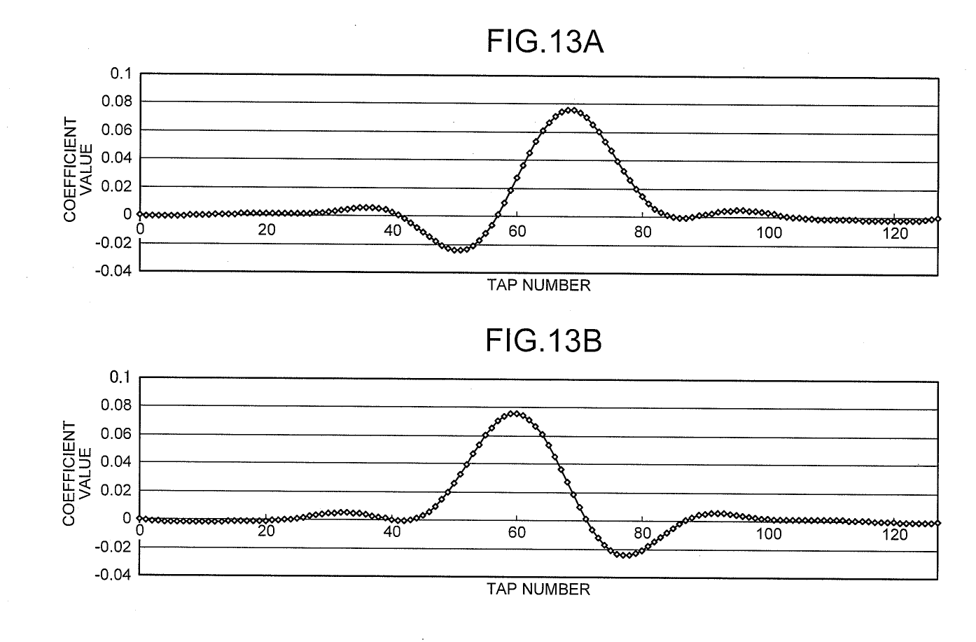

Next, with reference to FIG. 12 and FIGS. 13A and 13B, a second modification is explained. In the second modification, a sound in a high frequency band in which interference is liable to easily occur is output from a member provided separately from the speakers 11a and 11b.

That is, as illustrated in FIG. 12, a speaker device 102 according to the second modification is, in contrast to the case of the above-mentioned embodiment, provided with a tweeter 11c provided separately from the speakers 11a and 11b. The tweeter 11c includes a diaphragm 12c. The speaker device 102 is one example of an “electronic device”. The diaphragm 12c is one example of a “third diaphragm”.

Here, in the second modification, the tweeter 11c is provided so as to mainly output a sound toward the head of the occupant H. That is, the tweeter 11c is arranged so as to face physically in the A1 direction.

Furthermore, in the second modification, the tweeter 11c connects a high-pass filter 34c thereto via an amplifier 13c. In addition, each of the FIR filters 34a and 34b has a function as a low-pass filter in addition to a function of performing the phase control same as that in the case of the above-mentioned embodiment.

With this configuration, in the second modification, high frequency components of both the first sound and the second sound are filtered by the FIR filters 34a and 34b. Furthermore, a high frequency component in an input signal is output from the tweeter 11c that outputs a sound toward the head of the occupant H (see the arrow A1) via the high-pass filter 34c. Accordingly, it is possible to output a sound in a high frequency band from the tweeter 11c provided separately from the speakers 11a and 11b toward the head of the occupant H in a state of giving directivity physically to the sound thus avoiding the occurrence of the interference of sounds attributed to the sounds in the high frequency band respectively output from the speakers 11a and 11b in a state that the phases of the sounds are shifted each other.

FIGS. 13A and 13B are exemplary diagrams illustrating filter coefficients to be set in the FIR filters 34a and 34b, respectively. The filter coefficient illustrated in FIG. 13A is designed such that the phase of the first sound in a low-pitched sound range is delayed by π/4 with respect to an input signal. The filter coefficient illustrated in FIG. 13B is designed such that the phase of the second sound in a low-pitched sound range is advanced by π/4 with respect to the input signal.

### Third Modification

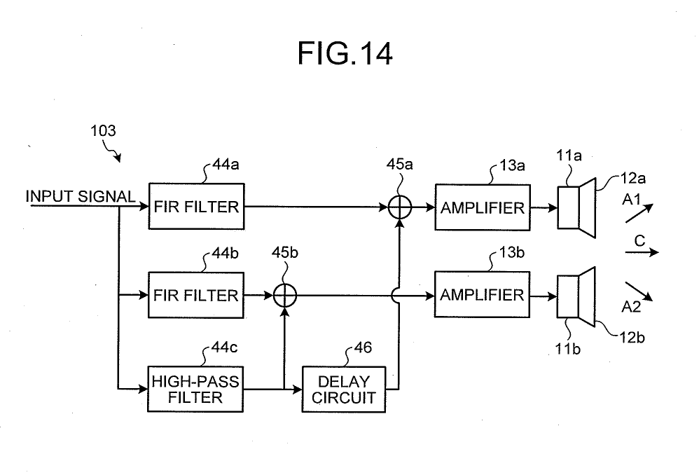

Next, with reference to FIG. 14, a third modification is explained. The third modification is configured such that delay in time corresponding to a path difference between the first sound and the second sound is generated by a physical circuit without relying on a filter coefficient.

As illustrated in FIG. 14, a speaker device 103 according to the third modification is provided with the speakers 11a and 11b, the amplifiers 13a and 13b, FIR filters 44a and 44b, a high-pass filter 44c, mixers 45a and 45b, and a delay circuit 46. The speaker device 103 is one example of an “electronic device”.

The mixer 45a is provided between the amplifier 13a and the FIR filter 44a. The high-pass filter 44c is connected to the mixer 45a via the delay circuit 46. The mixer 45b is provided between the amplifier 13b and the FIR filter 44b. The high-pass filter 44c is connected to the mixer 45b without passing through the delay circuit 46.

Here, in the third modification also, in the same manner as the case of the above-mentioned second modification, each of the FIR filters 44a and 44b has a function as a low-pass filter in addition to a function of performing the phase control in the same manner as the case of the above-mentioned embodiment. Furthermore, the delay circuit 46 has a function of generating delay in time corresponding to a path difference between the first sound and the second sound.

With this configuration, in the third modification, the first sound becomes a sound including a high frequency component delayed by passing through the delay circuit 46. Furthermore, the second sound becomes a sound including an undelayed, high frequency component. Accordingly, it is possible to easily obtain the same effects as the case of the above-mentioned embodiment without using the filter coefficient incorporating delay in time therein.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
giving a phase difference between a first phase of a first sound output from a first diaphragm and a second phase of a second sound output from a second diaphragm, the first diaphragm and the second diaphragm arranged adjacent to each other in a first direction toward a head portion of a listener, the first diaphragm and the second diaphragm extending in a second direction substantially intersecting with the first direction.

2. The method of claim 1, wherein
the first phase is delayed with respect to a third phase of an input signal, and
the second phase is advanced with respect to the third phase.

3. The method of claim 2, wherein
the first phase is delayed by a fourth phase with respect to the third phase, and
the second phase is advanced by the fourth phase with respect to the third phase.

4. The method of claim 3, wherein the fourth phase is π/4.

5. The method of claim 1, further comprising:
providing a phase difference between the first phase and the second phase in a first frequency band, the phase difference corresponding to a path difference between the first sound and the second sound.

6. The method of claim 1, further comprising:
filtering a first frequency component of one of the first sound and the second sound.

7. The method of claim 1, further comprising:
filtering first frequency components of both the first sound and the second sound; and
outputting a second frequency component of an input signal from, a third diaphragm provided separately from the first diaphragm and the second diaphragm and arranged to output a sound mainly toward the head portion of the listener.

8. The method of claim 1, further comprising:
filtering a first frequency component of the first sound; and
outputting a second frequency component of an input signal, together with the first sound, from the first diaphragm in a state that a time difference is provided, the time difference corresponding to a path difference between the first sound and the second sound.

9. An electronic device comprising:
a first diaphragm and a second diaphragm arranged adjacent to each other in a first direction toward a head portion of a listener and extending in a second direction substantially intersecting with the first direction; and
a filter to give a phase difference between a first phase of a first sound output from the first diaphragm and a second phase of a second sound output from the second diaphragm.

10. The electronic device of claim 9, wherein the filter comprises to delay the first phase with respect to a third phase of an input signal, and to advance the second phase with respect to the third phase.

11. The electronic device of claim 10, wherein the filter comprises to delay the first phase by a fourth phase with respect to the third phase and to advance the second phase by the fourth phase with respect to the third phase.

12. The electronic device of claim 11, wherein the fourth phase is π/4.

13. The electronic device of claim 9, wherein the filter comprises to provide a phase difference between the first phase and the second phase in a first frequency band, the phase difference corresponding to a path difference between the first sound and the second sound.

14. The electronic device of claim 9, wherein the filter comprises to filter a first frequency component of one of the first sound and the second sound.

15. The electronic device of claim 9, further comprising:
a third diaphragm provided separately from the first diaphragm and the second diaphragm and arranged to output a sound mainly to the head portion of the listener, wherein
the filter comprises to filter first frequency components of both the first sound and the second sound, and to output a first frequency component of an input signal from the third diaphragm.

16. The electronic device of claim 9, wherein the filter comprises to filter a first frequency component of the first sound, and to output a second frequency component of an input signal, together with the first sound, from the first diaphragm in a state that a time difference is provided, the time difference corresponding to a path difference between the first sound and the second sound.
